(19) United States
(12) Patent Application Publication
(10) Pub. No.: US 2011/0163128 A1
(43) Pub. Date: Jul. 7, 2011

(54) BEVERAGE CONTAINER AND COOLING SYSTEM FOR THE SAME

(75) Inventors: Masatake Taguchi, Ibaraki (JP); Yositaka Tomino, Ibaraki (JP)

(73) Assignee: ASAHI BREWERIES, LTD., Sumida-ku (JP)

(21) Appl. No.: 12/672,451

(22) PCT Filed: Aug. 7, 2008
(86) PCT No.: PCT/JP2008/064220

§ 371 Date: Feb. 5, 2010

(30) Foreign Application Priority Data
Aug. 9, 2007 (JP) 2007-207731
May 13, 2008 (JP) 2008-125752

(51) Int. Cl. B67D 7/80; B67D 7/06; F25B 21/02

(52) U.S. Cl. 222/146.6; 222/394; 62/3.2

(57) ABSTRACT

A beverage container which preserves a beverage and dispenses the beverage using a pressurized gas; comprising a beverage storage section having a liquid outlet, an outer wall, which covers an outer periphery of the beverage storage section and is separated from the beverage storage section by a hollow section, and a gas outlet which communicates the hollow section and an outer area; wherein the hollow section is filled with a pressurized gas.

### TECHNICAL FIELD

The present invention relates to a beverage container having a beverage storage section and a hollow section filled with a pressurized gas, wherein a beverage included in the storage section can be served to the outside by the pressure of the pressurized gas due to a server attached to the container. Furthermore, the present invention relates to a cooling system for the beverage container which includes a beverage container and a cooling device which can cool the beverage container.

Priority is claimed on Japanese Patent Application No. 2007-207731, filed Aug. 9, 2007, and Japanese Patent Application No. 2008-125752, filed May 13, 2008, the content of which is incorporated herein by reference.

### BACKGROUND ART

As a conventional beverage container which can hold a beverage such as beer and dispense the beverage to the outside due to the pressure of a pressurized gas after a server is attached to the container as a supply head, containers disclosed in the Patent Documents 1 and 2 have been proposed, for example.

A container device which dispenses a liquid suitable for drink such as beer, wine, mineral water and juice, by the pressure of a gas such as CO₂ is disclosed in Patent Document 1. The container device is characterized in that the container device includes a beverage container equipped with a connecting head and a shared valve for a gas and a liquid, the connecting head can be detachably connected to the shared valve and dispenses a beverage from the beverage container, and gas is supplied to the beverage container via a pressure reducing valve from a liquefied gas storage tank which is one or more high pressure containers. At least one of said high pressure containers used for a liquefied gas is integrated with the aforementioned beverage container to form an integrated structural unit.

Patent Document 2 discloses a beverage server for gas-serving, wherein a beverage such as beer, wine, soft drink or the like is served at the controlled temperature suitable for drink, using a pressurized gas such as a CO₂ pressurized gas. The beverage server includes; a container which preferably has a columnar form and is separated, with a bell-shaped partition wall, into a beverage portion provided at the bottom side of the server and a ring-shaped pressurized gas portion provided at the cover side of the server; an upper gas valve for a beverage, which is provided at the beverage portion and equipped with a riser tube; a gas valve which is provided at the pressurized gas portion; a removable tap head which communicates with the said gas valves; a head ring; and a foot ring. The length in the axial direction of the upper portion of the container (the pressurized gas portion) is approximately the same with the length in the axial direction of the partition wall but shorter than the length in the axial direction of the lower portion of the container (the beverage portion). Furthermore, the upper portion, the lower portion and the partition wall, which have approximately same diameter, are connected to each other, and three edges thereof are joined at one common butt-welding joint. Said both portions of the container have safety-blowoff parts. Furthermore, an outer periphery of the head ring has no protrusive part which extends outward over an outer periphery of the beverage container. The head ring has a first fitting portion by which a tap head, to which a pressure-regulating device is integrated, is located correctly in relation to the gas valve, and a second fitting portion by which the head ring is located correctly in relation to the gas valve.

Furthermore, as a device having a cooling means which cools and reserves a beverage container, for example, a beverage cooling device having a cooling container included in an armor housing is disclosed in Patent Document 3. In the cooling device, a Peltier device and a radiator for the Peltier device are attached to the cooling container, a beverage extraction instrument is attached to the front surface of the armor housing, and the Peltier device and the radiator are attached to the rear surface of the armor housing.
Patent Document 1: Japanese Patent No. 2772089
Patent Document 2: Japanese unexamined Patent Application, First Publication
Patent Document 3: Japanese unexamined Patent Application, First Publication No. 2000-171142

### DISCLOSURE OF INVENTION

### Problems to be solved by the Invention

The aforementioned conventional arts have problems as described below. The beverage containers disclosed in Patent Documents 1 and 2 have a high pressure container, which is used for a liquefied gas and is integrated with the beverage containers. However, the beverage storage portion thereof is exposed to the outside, and therefore cold-preserving effect is not expected.

Furthermore, there are problems such that the high pressure container used for a liquefied gas of Patent Document 1 costs too much, and the total volume of the container of Patent Document 2 is large.

The beverage cooling device disclosed in Patent Document 3 has a structure as shown in FIG. 3 wherein a cooling container 2 is installed in an armor housing 1, and cans of beer 3 are stored in the cooling container 2 via a refrigerant liquid 31. A Peltier device 4 is attached to the rear surface of the a cooling container 2, and the cooling container 2 is cooled with the Peltier device 4 via a cooling board 23 so that the cans of beer 3 in the cooling container 2 are cooled by the refrigerant liquid 31 such as water. However, there is a problem such that the size of the cooling device becomes large, since the Peltier device 4, a radiator 4′ and the like are installed such that the rear surface of the cooling container 2 is protruded outward, that is, the rear surface of the cooling device is protruded toward the transverse direction.

Furthermore, since the beverage cooling device has the structure such that cans of beer 3 in the cooling container are cooled by the refrigerant liquid 31 such as water, there is a problem that the refrigerant liquid easily leaks due to the sway when the device is conveyed as a whole or the device is loaded on a vehicle.

The present invention is achieved in view of the aforementioned circumstances, and the purpose of the present invention is to provide a compact beverage container excellent in cold-preserving properties, wherein the container holds a beverage such as beer, which can be supplied by a compressed gas, a peripheral surface of a beverage storage section thereof is covered with an outer wall and is separated from the outer wall by a hollow section, and the hollow section is filled with a pressurized gas.

Furthermore, the purpose of the present invention is to provide a cooling system having a beverage container which can dispense a beverage to the outside and a cooling device which can cool the beverage container, wherein the cooling system has excellent cold-preserving properties and enables a reduced total size of the system.

### Means for solving the Problems

The first aspect of the present invention is to provide a beverage container which preserves a beverage and dispenses the beverage using a pressurized gas; comprising a beverage storage section having a liquid outlet, an outer wall, which covers an outer periphery of the beverage storage section and is separated from the beverage storage section by a hollow section, and a gas outlet which communicates the hollow section and an outer area; wherein the hollow section is filled with a pressurized gas.

In the beverage container of the present invention, it is preferable that the outer wall covers all of the parts of the beverage container except for the bottom of the beverage storage section and the liquid outlet.

In the beverage container of the present invention, it is preferable that the beverage container comprises a reinforcing part which connects the beverage storage section and the outer wall.

In the beverage container of the present invention, it is preferable that a server is attached to the liquid outlet of the beverage container, and the server has an operating part, wherein the server supplies a pressurized gas included in the hollow section from the gas outlet to the interior of the beverage storage section via a pressure reducing valve, the operating part switches between dispending and not dispending a beverage included in the beverage storage section through an extraction tube, and a lower end of the extraction tube exists in the vicinity of an inner bottom of the beverage storage section.

The second aspect of the present invention is a cooling system of a beverage container which preserves a beverage and dispenses the beverage using a pressurized gas, wherein the cooling system comprises:

a beverage container which comprises a beverage storage section having a liquid outlet, an outer wall, which covers an outer periphery of the beverage storage section and is separated from the beverage storage section by a hollow section, and a gas outlet which communicates the hollow section and an outer area, wherein the hollow section is filled with a pressurized gas; and

a cooling device which is provided at a part of the beverage container which the outer wall does not cover.

In the cooling system of the beverage container of the present invention, it is preferable that the outer wall covers all of the parts of the beverage container except for the bottom of the beverage storage section and the liquid outlet, and the cooling device is placed under the bottom of the beverage container.

In the cooling system of the beverage container of the present invention, it is preferable that the cooling device has a Peltier device.

### EFFECTS OF THE INVENTION

The beverage container of the present invention has a structure which comprises a beverage storage section having a liquid outlet, an outer wall which covers an outer surface of the beverage storage section and is separated from the beverage storage section by a hollow section, and a gas outlet which communicates the hollow section and an outer area, and the hollow section is filed with a pressurized gas. Especially, the outer periphery of the beverage storage section is surrounded by a hollow section which has excellent heat insulation properties. Accordingly, the cold-preserving property of the beverage storage section increases, and it is possible to maintain a cold state of a beverage included in the beverage container, even after the beverage container is left for a long period of time at room temperature subsequent to cooling of the beverage container in a refrigerator or the like.

Furthermore, the beverage container of the present invention has a structure wherein an outer periphery of the beverage storage section is covered with an outer wall and is separated from the beverage storage section by a hollow section. Accordingly, the structure thereof is simple as compared with the containers of conventional arts disclosed in Patent Document 1 and 2, and it is possible to produce the beverage container of the present invention at low cost.

Furthermore, it is possible to generate a compact beverage container wherein the total volume is relatively small since the beverage container of the present invention has a structure wherein an outer wall covers an outer periphery of the beverage storage section and is separated from the beverage storage section by a hollow section.

The cooling system of a beverage container of the present invention has a structure which includes; a beverage container which comprises a beverage storage section having a liquid outlet, an outer wall which covers an outer periphery of the beverage storage section and is separated from the beverage storage section by a hollow section, and a gas outlet which communicates the hollow section and an outer area, wherein the hollow section is filled with a pressurized gas. Especially, the cooling system of the present invention has a structure wherein an outer periphery of the beverage storage section is surrounded by a space which has excellent heat insulation properties. Accordingly, the cold-preserving properties of the beverage storage section increases, and it is possible to maintain a cold state of a beverage in the beverage container even after the beverage container is left for a long period of time at room temperature subsequent to cooling in a refrigerator or the like.

Furthermore, a cooling device is placed at the position where the outer wall does not cover the beverage container, which has excellent cold-preserving properties, in order to cool the beverage container. Therefore, it is possible to achieve cold-preserving of a beverage container with small energy for cooling.

Furthermore, when the cooling system of a beverage container of the present invention has a structure, wherein the outer wall covers all of the parts of the beverage container except for the bottom of the beverage storage section and the liquid outlet, and the cooling device is provided as the bottom of the cooling system, the cooling device can be placed without protruding from the outer wall, that is, without waste of space, and it is possible to miniaturize the cooling system.

### BRIEF DESCRIPTION OF THE DRAWINGS

FIG. 1 is a cross-sectional view which shows a first embodiment of a beverage container of the present invention.

FIG. 2 is a cross-sectional view which shows a second embodiment of a beverage container of the present invention.

FIG. 3 is a cross-sectional view which shows the first embodiment of a cooling system of a beverage container of the present invention.

FIG. 4 is a cross-sectional view which shows the second embodiment of a cooling system of a beverage container of the present invention.

FIG. 5 is a schematic structural view which shows a cooling device which is used in the cooling system of the first and the second embodiments of the present invention.

### DESCRIPTION OF THE REFERENCE SYMBOLS

1 a beverage container
2 a liquid outlet
3 a beverage storage section
4 an outer wall
5 a hollow area
6 a gas outlet
7 a reinforcing part
8 a lid part
9 an extraction tube
10 a server
11 a pressurized gas supply line
12 a pressure reducing valve
13 a control lever
14 a beverage
15 an external protective member
16 a switch valve
21 a cooling device
22 a base
23 a Peltier device
24 a power supply
25 a control unit
26 a temperature sensor

### BEST MODE FOR CARRYING OUT THE INVENTION

Hereinafter, the embodiments of the present invention will be described with reference to figures. However, the present invention is not limited merely to the embodiments, and modifications and additions regarding the number, position, volume and the like are possible, insofar as the content of the present invention does not deviated from.

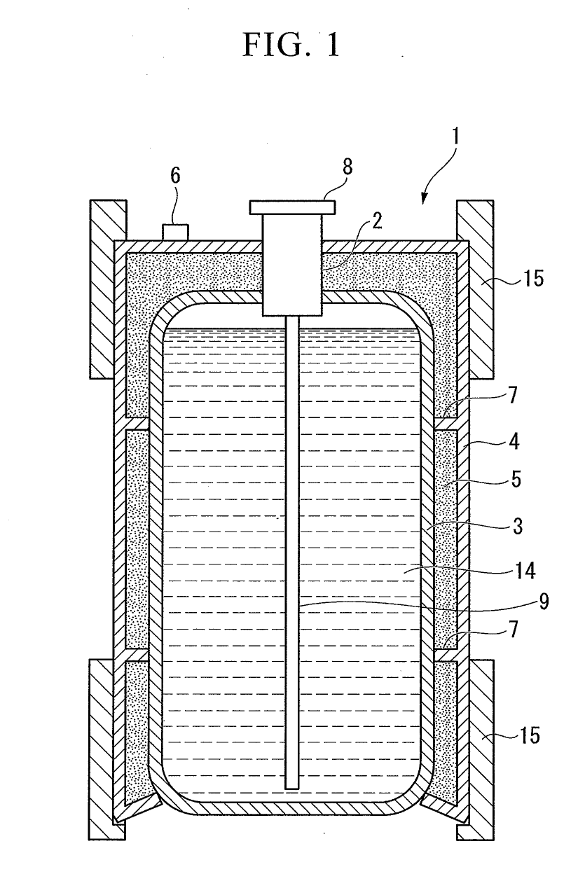

FIG. 1 is a cross-sectional view which shows the first embodiment of a beverage container of the present invention. The beverage container 1 of the embodiment has, as a main characteristic, a beverage storage section 3 having a liquid outlet 2, an outer wall 4 which covers an outer periphery of the beverage storage section 3 and is separated from the beverage storage section by a hollow section 5, and a gas outlet 6 which communicates the hollow section 5 and an outer area; and the hollow section is filled with a pressurized gas.

In the beverage container 1 of the embodiment, all of the parts of the beverage container except for the bottom of the beverage storage section 3 and the liquid outlet 2 are encased by the outer wall 4, and therefore, the part of the container where the outer wall 4 exists has a double-container structure.

Resins and the like can be used for materials and in a method for forming the outer wall 4 and the beverage storage section 3, but metal is preferably used. A metal plate, for example, such as stainless steel, aluminum, an aluminum alloy or carbon steel can be treated to provide the desired structure of the outer wall and the beverage storage section.

When the beverage container 1 of the present embodiment is intended to be used in the form of a returnable container, stainless steel is preferably used since stainless steel has greater strength and superior corrosion resistance among the aforementioned metals.

In the beverage container 1 of the present embodiment, the outer wall 4 and the beverage storage section 3 are connected to each other using a plurality of reinforcing parts 7. As shown in FIG. 1, reinforcing parts 7 are protruded annularly from the interior surface of the outer wall 4 toward the inside, and a beverage storage section 3 is fitted in the outer wall 4 so that the outer periphery of the bottom of the beverage storage section 3 is airtightly jointed to protruded ends of the reinforcing parts 7 existing at the bottom position. However, the jointing structure between the outer wall 4 and the beverage storage section 3 and the structure of the reinforcing parts 7 are not limited to the aforementioned example. For example, in order to ensure an air tight seal, it is possible to adopt a structure wherein a rubber packing or an o-ring intervenes between them, or a structure wherein the bottom of the section is covered with a resin. Although the hollow section 5 may be divided into a plurality of parts by the reinforcing parts 7, it is preferable that all of the plurality of parts of the hollow section 5 are connected to each other by an appropriate method. It is also possible that the hollow section 5 optionally has a part which is not connected to other parts which includes a pressurized gas. The bottom of the beverage storage section 3 and the lowest position of the outer wall 4 may exist at the same height or at the different heights. It is preferable that the lowest position of the outer wall 4 be at a position lower than the bottom of the beverage storage section 3.

In the beverage container 1 of the present embodiment, the form of a columnar portion of the beverage storage section 3 is not limited, and can be suitably selected. For example, when the columnar portion is observed as a plane in the horizontal direction, the observed shape thereof may be a circle, an elliptical shape, an ellipse, a polygon such as a square or a rectangle, or the like. When the shape of the columnar portion, which is observed as a plane, is a polygon, it is preferable that the corners of the polygon have a rounded shape. Furthermore, the shape and the area of the columnar portion, which are observed as a plane in the horizontal direction, of the beverage storage section 3 is not necessary to be identical in any position of the columnar portion, that is, the shape and the area of the cylindrical portion observed as a plane may be changed along the column if necessary. When the beverage storage section 3 has the bottom wherein edges thereof have a rounded form (curved portion), the bottom of the beverage storage section may mean a bottom including rounded ends. The bottom of the beverage storage section may optionally include a part of the curved portion.

In the beverage container 1 of the present embodiment, a lid part 8 having a container side extraction tube 9, which extends to the vicinity of the inner bottom of the beverage storage section 3, is attached to the liquid outlet 2 of the beverage storage section 3. A server side extraction tube 9, which is positioned at the server side, is connected to the upper end of said lid part 8, when a server 10, which is described below, is attached to the beverage container. The container side extraction tube and the server side extraction tube can be used as a unified extraction tube by the bonding them, and therefore, these tubes have the same reference number 9 in the figures. Furthermore, a unified extraction tube, which is a combination of said tubes, is also shown as a unified extraction tube 9. The bonding of the aforementioned tubes may be conducted by any method insofar as a beverage can be transferred. In the present invention, the detailed structure of the liquid outlet 2 is not limited in particular and can be selected optionally. For example, when a long extraction tube, which extends in the container, is provided at the server side, a structure can be adopted wherein a screw cap is screw-thread to a liquid outlet which has a cylindrical structure and extends outward.

In the beverage container 1 of the present embodiment, the gas outlet 6 is not limited in particular and can be selected optionally, insofar as the gas outlet 6 makes it possible to communicate the pressurized gas filled in the hollow section 5 to the outside when such a communication is required. A gas outlet 6, which can accommodate the end structure of a pressurized gas supply line of the server 10, can be selected to form a combined structure thereof. For example, such a structure is adoptable wherein a communicating hole is made at the upper portion of the outer wall 4, the communicating hole is sealed with a plug, which is made of a material such as a rubber, so that opening and closing of the hole is possible, and the pressurized gas in the hollow section 5 is supplied to the pressurized gas supply line when the end of the pressurized gas supply line at the side of the server 10 is attached to the plug.

The beverage container 1 of the present embodiment is structured such that an external protective member 15 is mounted on an upper outer surface and a lower outer surface of the outer wall 4 so that the beverage container 1 is protected from impact provided at the time of transfer, usage or the like thereof. In order to enable excellent impact resistance, a molded product made of a synthetic resin or a foamed resin, which are comparatively soft, is preferably used as the external protective member 15.

A suitable beverage can be selected as a beverage 14 preserved in the beverage storage section 3 of the beverage container 1. For example, alcoholic beverages such as beer, wine and low-malt beer, and soft drinks such as mineral water and juice can be preserved. Among them, beer (draft beer) is most preferably preserved.

A suitable gas can be selected as a pressurized gas filled in the hollow section 5 of the beverage container 1. Examples thereof include inert gas such as carbon dioxide gas (CO₂) and nitrogen gas, and said carbon dioxide gas is particularly preferable. An appropriate pressure can be selected as the pressure of the pressurized gas filled in the section 5. For example, a suitable pressure thereof is about 0.3 to 0.9 MPa, and more preferably about 0.5 to 0.7 MPa. Appropriate volume can be selected as the volume of the beverage container. For example, the volume is preferably about 1.0 to 10.0 L, and more preferably about 2.0 to 5.0 L. The length from the outer surface of the beverage storage section to the inner surface of the outer wall can be preferably selected. For example, the length may be 2 to 10 mm, and is preferably 4 to 8 mm.

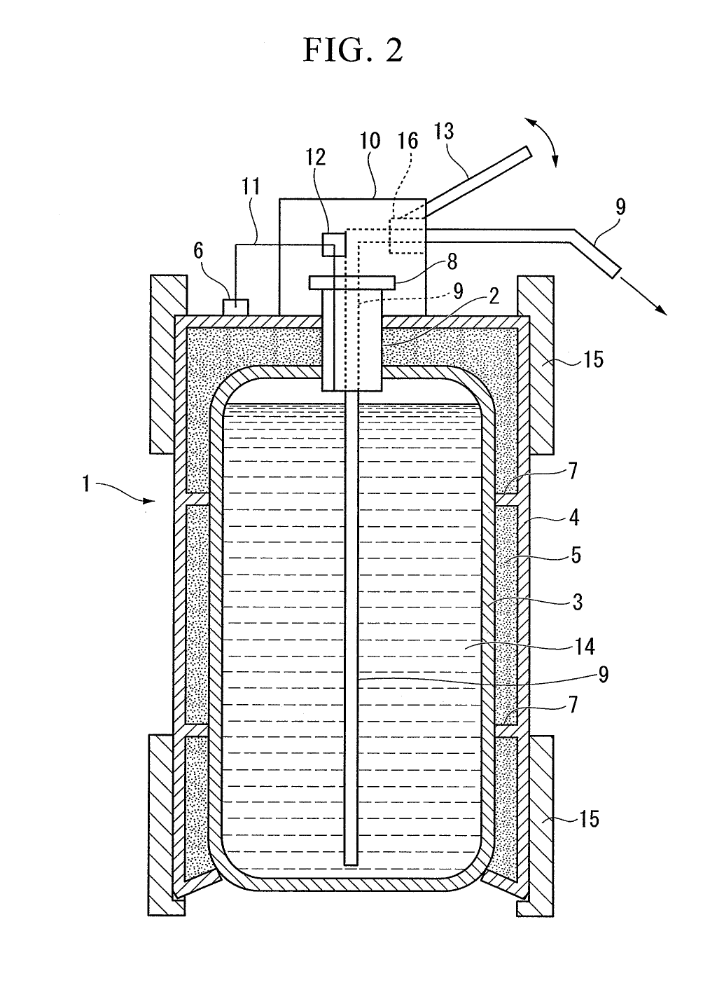

FIG. 2 is a cross-sectional view which shows the second embodiment of a beverage container of the present invention. The beverage container of the second embodiment has a structure wherein a server 10 is attached to the beverage container 1 of the aforementioned first embodiment. In FIG. 2, constituent elements in common with those of the beverage container 1 of the first embodiment are denoted by the same symbols.

In the second embodiment, a server 10 is attached to the liquid outlet 2 of the beverage container 1 of the first embodiment. The attached server 10 comprises: a server side extraction tube 9 which is connected to a container side extraction tube 9 at the upper end of the lid part 8 to extend to the outside of the container; a pressurized gas supply line 11, which has one end connected to the gas outlet 6 and supplies the pressurized gas from the hollow section 5 to the beverage storage section 3 via the lid part 8 (or another part); a pressure reducing valve 12 which is located at the middle of the pressurized gas supply line 11; a switch valve 16 which is located at the middle of the server side extraction tube 9; and a control lever 13 which is connected such that the switch valve 16 can switch between supplying and not supplying a beverage by the control lever 13.

In the beverage container, a beverage 14 such as beer is preserved in the beverage storage section 3 of the beverage container 1 as show in FIG. 1, and a pressurized gas such as carbon dioxide is filled in the hollow section 5 so that the predetermined pressure is achieved. The beverage container is shipped in this state as a product. A consumer, who bought and held the beverage container 1, sets a server 10 to a liquid outlet 2 of the container after preserving the beverage container in a refrigerator for cooling. Due to the setting of the server, the pressurized gas included in the hollow section 5 can be supplied to the beverage storage section 3 via a pressurized gas supply line 11 and a pressure reducing valve 12, and the internal pressure of the beverage storage section 3 increases.

Then, when the consumer switches a control lever 13 to the side where a drink can be dispensed while the consumer holds a glass, a jug or the like near an outlet of a sever side extraction tube 9, a switch valve 16 opens. Then, a beverage 14 is extracted from the beverage storage section 3, wherein the internal pressure has been increased, and the extracted beverage enters into the lower end of the container side extraction tube 9, is passed through the server side extraction tube 9, and is dispensed from the outlet of the server side extraction tube. When the consumer stops pouring, the control lever 13 is switched to the other side so that dispension of the beverage 14 is stopped. The server 10 may be packed with the beverage container as a single product, or may be provided to the consumer separately from the container.

The aforementioned beverage containers 1 of each embodiment described above have structures wherein the outer surface of the beverage storage section 3 is covered with a space having excellent heat insulation properties. Accordingly, cold-preserving properties of the beverage storage section increase, and it is possible to maintain the temperature of a cold beverage included in the container even after the beverage container is maintained at room temperature for a long period of time subsequent to cooling the beverage container in a refrigerator or the like. Furthermore, the beverage container of the present invention has a structure wherein an outer wall covers around the beverage storage section so that a space exists between the outer wall and the beverage storage section, and the structure thereof is simpler than the containers of the conventional art of Patent Documents 1 and 2. Accordingly, the beverage container of the present invention can be manufactured at a low cost.

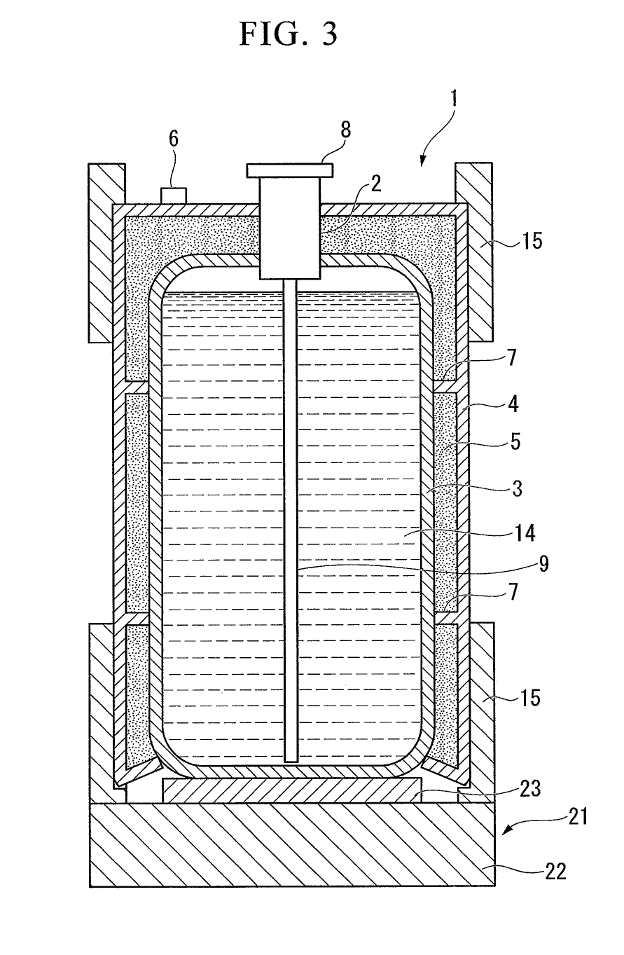

FIG. 3 is a cross-sectional view which shows the first embodiment of a cooling system of a beverage container of the present invention. The cooling system has a structure including a beverage container 1 and a cooling device; wherein the beverage container 1 includes a beverage storage section 3 having a liquid outlet 2, an outer wall 4 which covers an outer surface of the beverage storage section 3 so that the outer wall is separated from the beverage storage section by a hollow section 5, and a gas outlet 6 which communicates an outer area and the hollow section 5 filled with a pressurized gas; and the cooling device includes a Peltier device 23 and is placed so that the cooling device contacts with a part of the beverage container 1, which is not covered by the outer wall 5. Here, constituent elements in common with those of the beverage container 1 of the aforementioned embodiments are denoted by the same symbols, and a description of the effects and an explanation thereof are omitted.

In the present embodiment, an outer wall 5 covers all of the parts of the beverage container 3 except for the bottom of a beverage storage section 3 and a liquid outlet 2, and the cooling device 21 is placed under the bottom of the storage section.

Furthermore, the cooling device 21 in the embodiment is the cooling device having a Peltier device 23. However, the cooling device is not limited thereto. Another cooling device such as a gas compression system, a vapor compression system and a magnetic cooling system can be used in the present invention.

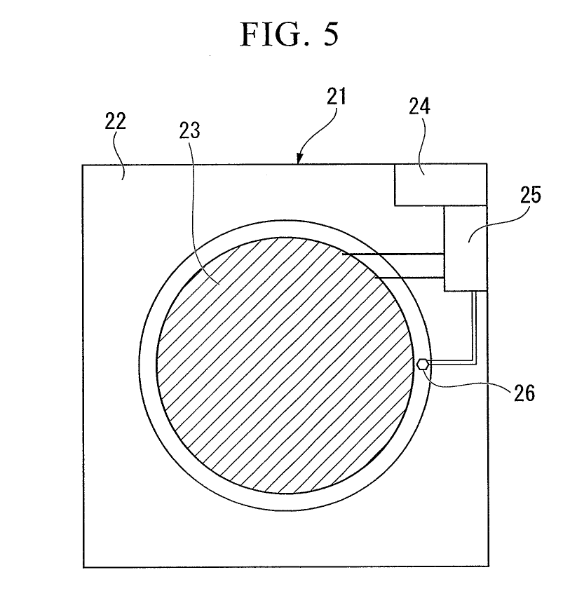

FIG. 5 is a schematic structural view which shows a cooling device 21 used in the cooling system of the present embodiment.

The cooling device 21 is structured such that the cooling device includes: a base 22 on which the aforementioned beverage container 1 is mounted; a Peltier device 23 which is provided at the center of the upper surface of the base 22; a power supply 24 which supplies power to the Peltier device 23; a temperature sensor 26 which measures the temperature of the outer surface of the beverage container 1 while the beverage container 1 is mounted on the base 22; and a control unit 25 which compares temperature control data, which has been stored in the unit, and temperature data, which is measured by the temperature sensor 26 and is inputted into the control unit 25, in order to control electric energy supplied to the Peltier device 23 or to control supplying or not supplying electric power to the Peltier device 23 so that the beverage container 1 maintains the predetermined temperature.

The Peltier device 23 used in the cooling devise 21 is not limited in particular. Among various commercial products, a suitable product which has moderate cooling ability can be selected and be used in order to reserve the beverage container 1 in the cold state. In the present embodiment, the Peltier device 23 is attached to the base 22 so that the cooling side of the Peltier device 23 faces upward, and therefore it is structured such that the cooling side of the Peltier device 23 contacts with the bottom surface of the beverage container 1 directly. Here, heat radiation of the Peltier device 23 can be performed from the heat radiating side of the Peltier device 23 by the heat transfer via the base 22 or by the air-cooling system using a radiator fin.

As a power supply 24 which is used in the cooling device 21, an appropriate power supply can be selected. Examples thereof include: a power supply which includes a combination of a rectifier and an electric coupler for wiring (outlet, plug and the like) which connects with domestic electric wiring; a power supply which includes an electric coupler for wiring, which connects to an electric battery of a vehicle, and supplies the predetermined amount of direct current to a Peltier device 23; a power supply which includes a rechargeable battery such as a lithium rechargeable battery; and a non-contact type power system which includes a non-contact type power supply coil. Here, a switch of the power supply 24 may be a manual type switch which a user can switch between ON and OFF, or a weight detecting type switch where the switch is turned on due to the weight of a beverage container 1 when the beverage container 1 is set on a base 22, and the power is turned off when the beverage container 1 is removed from the base 22.

As a control unit 25 used in the cooling device 21, an appropriate control unit can be selected. For example, a microcomputer can be used which controls a temperature such that the measured temperature data sent from the temperature sensor 26 is compared with a preset temperature which has been input in advance, electric power is supplied to a Peltier device 23 from a power supply 24 when the measured temperature exceeds the upper limit of the preset value, and electric power is not supplied when the measured temperature is below the upper limit of the preset value.

Here, the temperature controlling method used in the cooling device 21 is not limited to the aforementioned method wherein the temperature sensor 26 and the control unit 25 are used. The method can be structured such that an element such as a thermistor is used in order to control the electric power supplied to the Peltier device 23.

In the cooling system equipped with such a cooling device 21, a beverage container 1, in which beer or the like is stored, is set on a base 22 of the cooling device 21 to switch on the cooling device 21 (not shown in figures), the temperature of the outer surface of the beverage container 1 is measured by the temperature sensor 26 of the cooling device, and cooling is started by the cooling device 21 when the measured temperature exceeds the upper limit of the preset value.

Examples of the preferable form of the cooling system include a form wherein a beverage container 1, in which beer or the like is preserved, is cooled by being stored in a refrigerator or the like in advance, the cooled beverage container is taken out from the refrigerator when the container is used, and the beverage container 1 is mounted on a base 22 of a cooling device 21 to preserve a cold state of the beverage container 1. The beverage container 1 used in the embodiment has a double-container structure where an outer wall 4 covers all of the parts of the beverage container except for the bottom of the beverage storage section 3 and the liquid outlet 2, and therefore, the container has excellent cold-preserving properties. Accordingly, it is possible to maintain a beverage container 1, which has been cooled in a refrigerator or the like, at a suitable cold temperature at a small amount of energy. Furthermore, such a form is applicable even if the cooling device 21 is small.

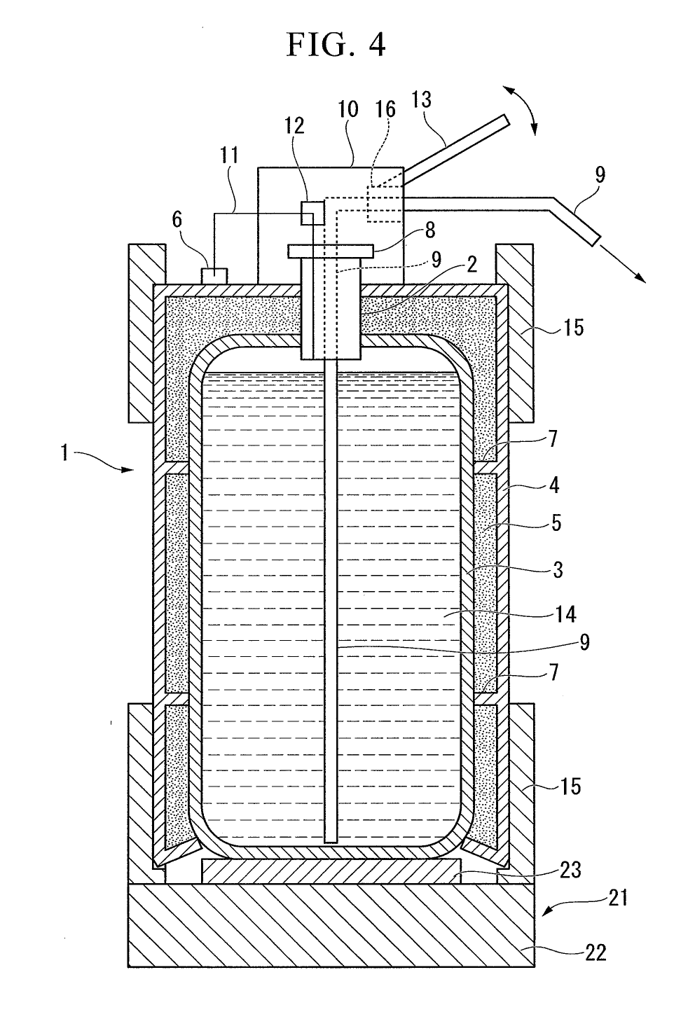

FIG. 4 is a cross-sectional view which shows the second embodiment of a cooling system of a beverage container of the present invention. The beverage container of the embodiment has a structure wherein a server 10 is attached to the beverage container 1 of the aforementioned cooling system of the first embodiment. Constituent elements in common with those of the beverage container 1 of the first embodiment are denoted by the same symbols and a description of the effects and an explanation thereof are omitted.

The cooling systems of the aforementioned first and second embodiments described above have a structure using a beverage container 1 in which an outer surface of the beverage storage section 3 is covered with a hollow section 5 with excellent cold-preserving properties. Accordingly, cold-preserving properties of the beverage storage section 3 increase, and it is possible to maintain a cold state of a beverage in the beverage container 1 even after the beverage container 1, which has been cooled in a refrigerator or the like, is left at room temperature for a long period of time.

Furthermore, since the beverage container has excellent cold-preserving properties and the cooling device is placed so that the cooling devices contacts with a part of the beverage container, which is not covered with an outer wall, the beverage container can be cooled by the cooling device and it is possible to achieve cold-preserving of the beverage container with a small amount of energy.

Furthermore, since the cooling system of a beverage container of the present invention has a structure where the outer wall covers all of the parts of the beverage container except for the bottom of the beverage storage section and the liquid outlet, and the cooling device exists at the bottom of the cooling system, the cooling system can be formed compactly with no part protruding from the outer wall, and it is possible to miniaturize the cooling system.

### INDUSTRIAL APPLICABILITY

The present invention can provide a beverage container which preserves beer or the like and dispenses it using a pressurized gas, wherein the beverage container is compact and has excellent cold-preserving properties since an outer wall covers a beverage storage section so that the outer wall is separated from the beverage storage section by a space and a pressurized gas fills the space. Furthermore, the present invention can provide a cooling system including a beverage container, which can dispense a beverage stored therein to the outside, and a cooling device, which can cool the beverage container, and the cooling system has excellent cold-preserving properties and enables a reduction in the total size thereof.

1. A beverage container which preserves a beverage and dispenses the beverage using a pressurized gas; comprising a beverage storage section having a liquid outlet, an outer wall, which covers an outer periphery of the beverage storage section and is separated from the beverage storage section by a hollow section, and a gas outlet which communicates the hollow section and an outer area; wherein the hollow section is filled with a pressurized gas.

2. The beverage container according to claim 1, wherein the outer wall covers all of the parts of the beverage container except for the bottom of the beverage storage section and the liquid outlet.

3. The beverage container according to claim 1, wherein the beverage container comprises a reinforcing part which connects the beverage storage section and the outer wall.

4. The beverage container according to claim 1, wherein a server is attached to the liquid outlet of the beverage container, and the server has an operating part, wherein
the server supplies a pressurized gas included in the hollow section from the gas outlet to the interior of the beverage storage section via a pressure reducing valve, the operating part switches between dispending and not dispending a beverage included in the beverage storage section through an extraction tube, and a lower end of the extraction tube exists in the vicinity of an inner bottom of the beverage storage section.

5. A cooling system of a beverage container which preserves a beverage and dispenses the beverage using a pressurized gas, wherein the cooling system comprises:
a beverage container which comprises a beverage storage section having a liquid outlet, an outer wall, which covers an outer periphery of the beverage storage section and is separated from the beverage storage section by a hollow section, and a gas outlet which communicates the hollow section and an outer area, wherein the hollow section is filled with a pressurized gas; and
a cooling device which is provided at a part of the beverage container which the outer wall does not cover.

6. The cooling system of a beverage container according to claim 5, wherein the outer wall covers all of the parts of the beverage container except for the bottom of the beverage storage section and the liquid outlet, and the cooling device is placed under the bottom of the beverage container.

7. The cooling system of a beverage container according to claim 5, wherein the cooling device has a Peltier device.
